(19) United States
(12) Patent Application Publication
(10) Pub. No.: US 2007/0145853 A1
(43) Pub. Date: Jun. 28, 2007

(54) ELECTRICAL BRUSH AND METHOD FOR MAKING THE SAME

(75) Inventor: HSIN-HO LEE, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,465

(22) Filed: Aug. 10, 2006

(30) Foreign Application Priority Data
Dec. 22, 2005 (CN) 200510121038.5

(51) Int. Cl. H01R 39/18; H01R 39/24

(52) U.S. Cl. 310/248; 310/251

(57) ABSTRACT

An electrical brush includes an electrically conductive base and a plurality of carbon nanotubes. The electrically conductive base has a contact surface. The carbon nanotubes are formed on the contact surface of the base and are configured for contacting with a rotary member. The method includes the steps of: providing an electrically conductive base having a contact surface; and forming a plurality of carbon nanotubes on the contact surface of the base. The electrical brush can be applied in various electrical machineries for efficiently collecting and transferring machine current over a long working period.

### FIELD OF THE INVENTION

The present invention relates to electric apparatus and, more particularly, to an electrical brush and a making method for the electrical brush.

### DESCRIPTION OF RELATED ART

Electrical brushes are typically used for collecting or transferring current in electric apparatus involving moving parts, such as motors or generators. Electrical brushes are reliable and reasonably efficient for many commercial and industrial applications. However, improved electrical brushes capable of more efficiently collecting and transferring machine current over a longer working period are desirable.

In high revolution speed electric apparatuses, resin-bonded brushes comprising graphite powder bonded using a binding agent are often used to provide improved rectification. However, when the electrical apparatus undergoes a temperature rise due to friction etc., the lubricating property of the brush itself deteriorates causing the temperature of the electric apparatus to rise further. In addition, the graphite has low wear resistance and high friction thereby decreasing the working life of the electrical brush and increasing frequency of replacement.

In order to reduce temperature in the brush, a metal layer having good electrical conducting properties, such as nickel, copper, gold, and silver, is coated over outer surfaces of the brush. When the metal layer of the brush is in slidable contact with a rotor apparent heat resistance between the two is decreased thereby suppressing the temperature rise. Although this metal layer can suppress the temperature rise to some extent, it is not sufficient for the temperature rise found in high-velocity revolution apparatuses. Furthermore, the metal layer has low wear resistance and chemical stability thereby producing undesirable shortcomings as discussed above, namely, lower working life and requiring more frequent replacement.

What is needed, therefore, is an electrical brush that has a relatively high wear resistance and has a relatively long working period.

What is also needed is a method for making the electrical brush.

### SUMMARY OF INVENTION

In accordance with a preferred embodiment, an electrical brush includes an electrically conductive base and a plurality of carbon nanotubes. The electrically conductive base has a contact surface. The carbon nanotubes are formed on the contact surface of the base and are configured for contacting with a rotary member.

A method for manufacturing an electrical brush includes the steps of: providing and electrically conductive base having a contact surface; and forming a plurality of carbon nanotubes on the contact surface of the base configured for contacting with rotary member.

Other advantages and novel features will be drawn from the following detailed description of preferred embodiments in conjunction with the attached drawings, in which:

### BRIEF DESCRIPTION OF THE DRAWINGS

Many aspects of the present electrical brush can be better understood with reference to the following drawings. The components in the drawings are not necessarily drawn to scale, the emphasis instead being placed upon clearly illustrating the principles of the present heat dissipation module. Moreover, in the drawings, like reference numerals designate corresponding parts throughout the several views.

FIG. 1 is a schematic, side plan view of an according to a preferred embodiment;

FIG. 2 is a flow chart of a method for making the electrical brush of FIG. 1;

FIG. 3 is an exemplary method for forming a plurality of carbon nanotubes of the electrical brush of FIG. 1; and

FIG. 4 is essentially similar to FIG. 1, but showing the electrical brush applied in an electric apparatus.

### DETAILED DESCRIPTION

Embodiments of the present electrical brush will now be described in detail below and with reference to the drawings.

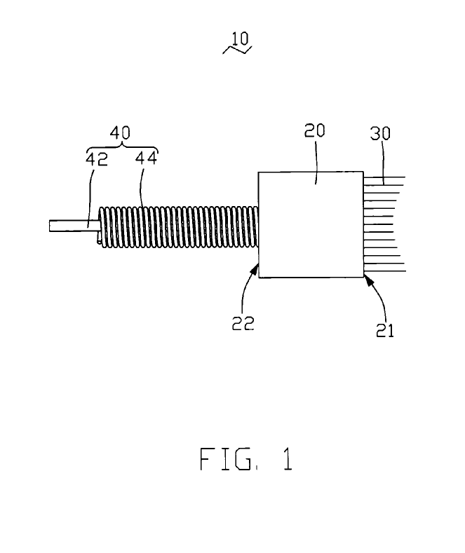

FIG. 1 illustrates an electrical brush 10 in accordance with a preferred embodiment. The electrical brush 10 includes an electrically conductive base 20, a plurality of carbon nanotubes 30, and an elastic connecting member 40. The base 20 has a contact surface 21 and a conductive surface 22 opposite to the contact surface 21. The carbon nanotubes 30 are formed on the contact surface 21 of the base 20. The elastic connecting member 40 is configured for elastically connecting with the conductive surface 22 of the base 20.

The base 20 is advantageously made of an electrically conductive material, for example, copper, gold, silver, nickel, or their combinations. The contact surface 21 of the base 20 may be a concave curved surface, for example, for fitting with a rotary member with a convex curved surface.

The carbon nanotubes 30 may be selected from the group consisting of: multi-walled carbon nanotubes, single wall carbon nanotubes, aligned carbon nanotube arrays, and combinations thereof. The carbon nanotubes 30 are advantageously aligned carbon nanotubes array essentially perpendicular to the contact surface 21 of the base 20.

Due to the curved contact surface 21 of the base 20, the carbon nanotubes 30 formed thereon form a corresponding curved contour at ends opposing the contact surface 21, for fitting with the rotary member. Alternatively, the contact surface 21 of the base 20 could be a flat plane. In this circumstance, the carbon nanotubes 30 can be treated to form a curved contour.

The elastic connecting member 40 includes an electrical lead 42 and a spring 44. The electrical lead 42 is foldable and electrically connects with the conduct surface 22 of the base 20. The spring 44 coils around the electrical lead 42 and elastically contacts with the conduct surface 22 of the base 20. Alternatively, the elastic member 40 could be a conductive elastic sheet connected with the base 20. The elastic sheet could be connected to a side surface adjacent to the contact surface 21 of the base 20.

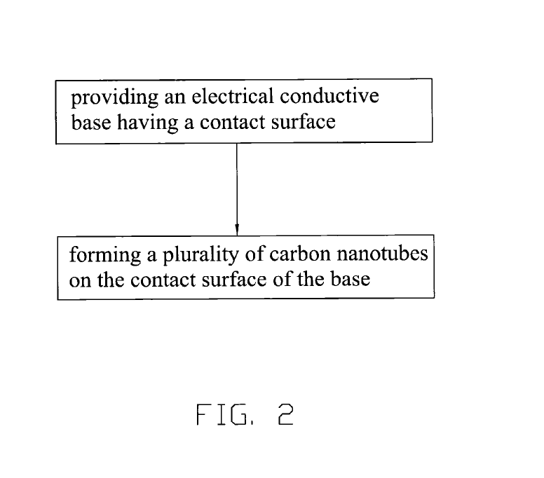

FIG. 2 illustrated a flow chart of a method for manufacturing the electrical brush 20 described above. The method mainly includes the steps of: providing the electrically conductive base 20 having the contact surface 21; and forming a plurality of carbon nanotubes 30 on the contact surface 21 of the base 20.

The carbon nanotubes are formed on the contact surface 21 of the base 20, for example, by using a chemical vapor deposition method, a plasma enhanced chemical vapor deposition method, a hot filament chemical vapor deposition method, an arc discharge method, a laser ablation method, etc. Preferably, the carbon nanotubes are directly grown on the contact surface of the base, for example, by a chemical vapor deposition method, a plasma enhanced chemical vapor deposition method, hot filament chemical vapor deposition method, etc. The carbon nanotubes formed may be multi-walled carbon nanotubes, single wall carbon nanotubes, aligned carbon nanotubes array, or their combinations.

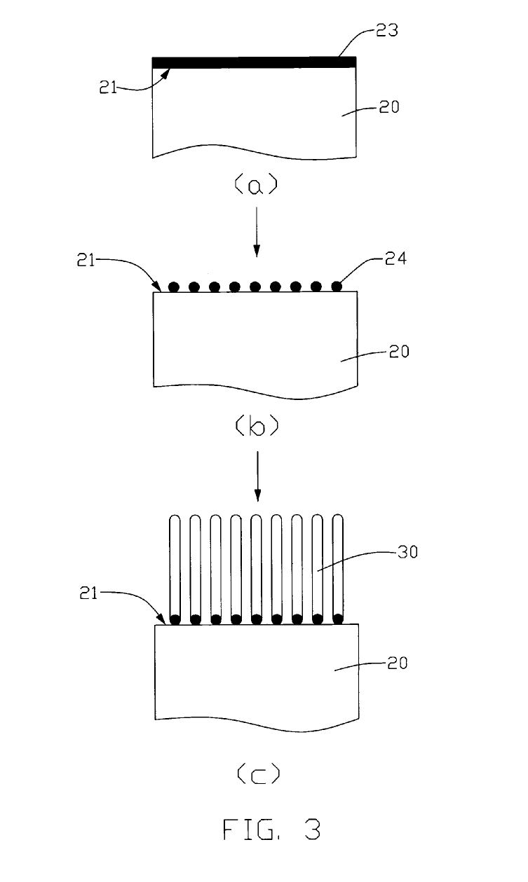

FIG. 3 illustrates an exemplary method for forming the carbon nanotubes 30 on the base 20. The exemplary method mainly includes the steps of: (a) forming a catalyst film 23 on the contact surface 21 of the base 20; (b) annealing the catalyst film 23 to form a plurality of catalyst particles 24 on the contact surface 21 of the base 20; and (c) growing a plurality of carbon nanotubes 30 on the contact surface 21 of the base 20.

In step (a), the catalyst film 23 is formed on the contact surface 21 of the base 20, for example, by an electron beam evaporation method, a vacuum sputtering method, a coating method, etc. A thickness of the catalyst film 23 is in the range from about 4 nanometers to about 10 nanometers. The catalyst film is made of a material selected from the group consisting of: iron, cobalt, nickel, and any alloy thereof.

The catalyst film 23 is annealed in air at a temperature ranged from about 300° C. to about 500° C. for about 8 to about 12 hours. During annealing, the catalyst film 23 is oxidized and forms a plurality of nano-sized catalyst particles 24 on the contact surface 21 of the base 20.

In step (c), the base 20 with the catalyst particles 24 formed thereon is placed in a furnace (not shown). A mixture of carbon source gas and protective gas is then introduced into the furnace at a predetermined temperature, e.g., from about 550° C. to about 1000° C. The carbon source gas can be acetylene, ethylene, or any suitable chemical compound containing carbon. The protective gas can be a noble gas or nitrogen. Preferably, the carbon source gas is acetylene, and the protective gas is argon. During the process, a plurality of carbon nanotubes 30 are grown from the catalyst particles 24. As such, the carbon nanotubes 30 are formed on the contact surface 21 of the base 20.

Furthermore, the elastic connecting member 40 can be connected with the base 20, for example, via soldering or an adhesive agent.

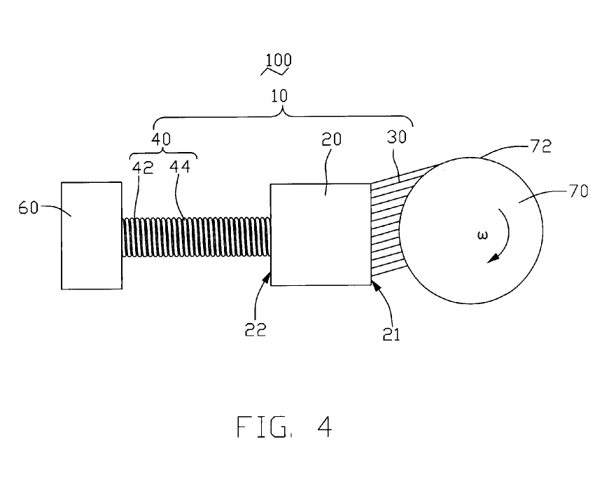

FIG. 4 illustrates an electric apparatus 100 using the electrical brush 10 described above. In addition to the electrical brush 10, the electric apparatus 100 includes a brush holder 60 and a rotary member 70. The electrical brush 10 elastically connects with the brush holder 60 via the elastic member 40. The contact surface 21 of the electrical brush 10 elastically abuts against the rotary member 70.

The rotary member 70 may be a rotor for an electric generator or an electric motor and has a cylindrical circumferential surface 72. Thus, the contact surface 21 in a curve form is advantageous to fit with the cylindrical circumferential surface of the rotary member 70.

In operation, the rotary member 70 revolves at a predetermined rotation speed. During the rotation of the rotary member 70, the carbon nanotubes 30 produces transformations, for example by bending or slanting due to continual friction and impact with the rotary member 70. As is known, the carbon nanotubes have characteristics such as high wear resistance, good anti-friction, electrical conductivity, excellent mechanical properties, good chemical stability, and flexibility. Thus, the carbon nanotubes 30 can undergo friction with the rotary member 70 over a long period of time thereby increasing the working life of the electrical brush 10.

The brush holder 60 is generally stationary. The spring 44 is elastically connected between the brush holder 60 and the base 20. Thus, the base 20 can passively generate an elastic movement in response to the rotation of the rotary member 70 to thereby reduce friction between the rotary member 70 and carbon nanotubes 30. Furthermore, the carbon nanotubes 30 while pressed between the peripheral surface 72 of the rotary member 70 and the contact surface 21 of the base 20, the carbon nanotubes 30 can produce a counter action against the rotary member 70 and the base 20. This counter action of the carbon nanotubes 30 assures close contact between the rotary member 70, the carbon nanotubes 30 and the base 20, thereby enabling a continuous electrical conduction between the rotary member 70 and the base 20. As a result, the electrical brush 10 can efficiently collect and transfer machine current over a longer working period.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. An electrical brush for an electric apparatus, comprising:
an electrically conductive base having a contact surface; and
a plurality of carbon nanotubes formed on the contact surface of the base and configured for contacting with the electrical apparatus.

2. The electrical brush as claimed in claim 1, wherein the carbon nanotubes form a concave curved contour at end opposing the contact surface of the base.

3. The electrical brush as claimed in claim 1, further comprising an elastic connecting member configured for elastically connecting the base with a brush holder.

4. The electrical brush as claimed in claim 3, wherein the elastic connecting member comprises an electrical lead connecting with the base and a spring coiled around the lead and elastically connecting with the base.

5. The electrical brush as claimed in claim 3, wherein the elastic connecting member comprises a conductive elastic sheet connecting with the base.

6. The electrical brush as claimed in claim 1, wherein the electrically conductive base is made of electrically conductive material selected from the group consisting of: copper, gold, silver, nickel, and combinations thereof.

7. The electrical brush as claimed in claim 1, wherein the carbon nanotubes are selected from the group consisting of: multi-walled carbon nanotubes, single wall carbon nanotubes, aligned carbon nanotubes array, and combinations thereof.

8. The electrical brush as claimed in claim 1, wherein the carbon nanotubes are an aligned carbon nanotube array essentially perpendicular to the contact surface of the base.

9. A method for manufacturing an electrical brush, comprising the steps of:
providing an electrically conductive base having a contact surface; and
forming a plurality of carbon nanotubes on the contact surface of the base configured for contacting with an electric apparatus.

10. The method as claimed in claim 9, wherein the forming of the carbon nanotubes is performed by a method selected from the group consisting of: chemical vapor deposition, plasma enhanced chemical vapor deposition, hot filament chemical vapor deposition, arc discharge, and laser ablation.

11. The method as claimed in claim 9, wherein the carbon nanotubes are directly grown on the contact surface of the base.

12. The method as claimed in claim 11, wherein the growing of the carbon nanotubes is performed by a method selected from the group consisting of: chemical vapor deposition, plasma enhanced chemical vapor deposition, and hot filament chemical vapor deposition.

13. The method as claimed in claim 12, wherein the growing of the carbon nanotubes comprises steps of: forming a catalyst film on the contact surface of the base; annealing the catalyst film to form a plurality of catalyst particles on the contact surface of the base; and growing a plurality of carbon nanotubes on the contact surface of the base.

14. An electric apparatus comprising:
a rotary member with a convex curved contour;
a brush holder; and
an electrical brush elastically connecting with the brush holder, the electrical brush comprising:
an electrically conductive base having a contact surface; and
a plurality of carbon nanotubes formed on the contact surface of the base and configured for contacting with the rotary member, the carbon nanotubes forming a concave curved contour fitting with the convex curved contour of the rotary emmber.

15. The electric apparatus as claimed in claim 14, wherein the electrical brush comprises an elastic connecting member elastically and electrically connecting the base with the brush holder.

16. The electric apparatus as claimed in claim 15, wherein the elastic connecting member comprises an electrical lead connected between the base and the brush holder and a spring coiled around the lead and elastically connected between the base and the brush holder.

17. The electric apparatus as claimed in claim 15, wherein the elastic connecting member comprises a conductive elastic sheet elastically and electrically connected to the base and the brush holder.

18. The electric apparatus as claimed in claim 14, wherein the contact surface of the base is a concave curved surface.

19. The electric apparatus as claimed in claim 14, wherein the contact surface of the base is a flat plane and the carbon nanotubes are treated to form the concave curved contour.

20. The electric apparatus as claimed in claim 14, wherein the brush holder is stationary relative to a center of the rotary member.
